(19) United States
(12) Patent Application Publication
(10) Pub. No.: US 2024/0050952 A1
(43) Pub. Date: Feb. 15, 2024

(54) REAGENT CONTAINER AND OPERATION METHOD THEREFOR, AND REAGENT TREATMENT SYSTEM

(71) Applicant: XIAMEN ZEESAN BIOTECH CO., LTD., Xiamen, Fujian (CN)

(72) Inventors: Wei ZHAN, Xiamen, Fujian (CN); Yi YANG, Xiamen, Fujian (CN); Dezhong WU, Xiamen, Fujian (CN)

(21) Appl. No.: 18/260,547

(22) PCT Filed: Jan. 7, 2022
(86) PCT No.: PCT/CN2022/070755

§ 371 Date: Aug. 18, 2023

(30) Foreign Application Priority Data
Jan. 8, 2021 (CN) 202110023377.9
Jan. 8, 2021 (CN) 202120045981.7

(51) Int. Cl. B01L 3/00; B01L 3/02

(52) U.S. Cl. CPC B01L 3/50825; B01L 3/0237; B01L 2200/0642; B01L 2200/16; B01L 2300/042; B01L 2200/0689; B01L 2300/0672; B01L 2300/044

(57) ABSTRACT

The present invention relates to a reagent container and an operation method therefor, and a reagent treatment system. The reagent container comprises a tube body and an elastic tube stopper, the tube body comprises a tube stopper accommodating section, the tube stopper accommodating section comprises a first inner diameter section and a second inner diameter section in the depth direction of the tube body, the inner diameter of the second inner diameter section is smaller than that of the first inner diameter section; the elastic tube stopper is provided with a through channel in a direction extending into the tube body; the elastic tube stopper can be in non-interference fit with or be fitted by a first interference magnitude with the first inner diameter section, and the elastic tube stopper can be fitted with the second inner diameter section by a second interference magnitude; when the elastic tube stopper can be in non-interference fit with the first inner diameter section, the second interference magnitude is larger than zero, and when the elastic tube stopper can be fitted with the first inner diameter section by the first interference magnitude, the second interference magnitude is larger than the first interference magnitude; and the through channel is configured to be compressed and sealed along with radial shrinkage of the elastic tube stopper when the elastic tube stopper is fitted with the second inner diameter section by the second interference magnitude

### CROSS REFERENCES TO RELATED APPLICATIONS

The present disclosure is based on and claims the priority of Chinese applications with application number 202110023377.9 and application number 202120045981.7 filed on Jan. 8, 2021, and the disclosures of these applications are incorporated by reference in their entirety into the present disclosure.

### TECHNICAL FIELD

The present disclosure relates to the technical field of biological detection, in particular to a reagent container, an operation method thereof, and a system for handling reagent.

### BACKGROUND ART

Polymerase chain reaction (PCR) is a molecular biological technique that can be used to amplify specific DNA fragments. The method can efficiently amplify a selective fragment of gene in vitro, and then realize the detection of a target gene.

In the operation of nucleic acid amplification, it is sometimes necessary to add or take out a part of preparation from a container. At this time, it is necessary to manually lift a lid of a reagent container, and then manually close the lid after adding or taking out a reagent.

Contents of the Invention

The present disclosure provides a novel reagent container, and the novel structure of the reagent container makes it particularly suitable for automatic operation.

In some aspects, the present disclosure discloses a reagent container, comprising:
a tube body, which comprises a tube plug accommodating segment, and the tube plug accommodating segment comprises a first inner diameter segment and a second inner diameter segment along the depth direction of the tube body, and the second inner diameter segment has an inner diameter smaller than that of the first inner diameter segment;
an elastic tube plug, in which the elastic tube plug is provided with a through-channel along the direction of entering the tube body;
wherein, the elastic tube plug is capable of being in non-interference fit or having a first amount of interference fit with the first inner diameter segment, and the elastic tube plug is capable of having a second amount of interference fit with the second inner diameter segment;
when the elastic tube plug is capable of being in non-interference fit with the first inner diameter segment, the second amount of interference fit is greater than zero; when the elastic tube plug is capable of having the first amount of interference fit with the first inner diameter segment, the second amount of interference fit is greater than the first amount of interference fit;
wherein, the through-channel is configured to be compressed and sealed with the radial contraction of the elastic tube plug when the elastic tube plug has the second amount of interference fit with the second inner diameter segment.

In some embodiments, both the first amount of interference fit and the second amount of interference fit are greater than zero.

In some embodiments, “non-interference fit” (amount of interference fit is greater than or equal to zero) is a transition fit (amount of interference fit is equal to zero/amount of clearance is equal to zero) or a clearance fit (amount of clearance is greater than zero).

In some embodiments, “the through-channel is compressed and sealed” means that at least part or all of the through-channel is compressed and sealed.

In some embodiments, the through-channel is open or naturally closed in the state of non-interference fit. “Naturally closed” means that when the elastic tube plug is not subjected to radial pressure, the through-channel is in a closed state only under the elastic pressure of the elastic tube plug itself. When the through-channel is in a naturally closed state, it can be penetrated by a pipette.

In some embodiments, the inner diameter of the first inner diameter segment is greater than or equal to at least one outer diameter of the elastic tube plug.

In some embodiments, the inner diameter of the second inner diameter segment is less than at least one outer diameter of the elastic tube plug.

In some embodiments, the elastic tube plug is in non-interference fit or has the first amount of interference fit with the first inner diameter segment at a first depth of entering the tube body, and has the second amount of interference fit with the second inner diameter segment at a second depth of entering the tube body, and the second depth is greater than the first depth.

In some embodiments, the first inner diameter segment and the second inner diameter segment are directly adjacent.

In some embodiments, a chamfered surface is provided between the first inner diameter segment and the second inner diameter segment.

In some embodiments, the first inner diameter segment gradually decreases in inner diameter at a position adjacent to the second inner diameter segment.

In some embodiments, the second inner diameter segment gradually increases in inner diameter at a position adjacent to the first inner diameter segment.

In some embodiments, there is a smooth transition of inner diameter at the junction of the first inner diameter segment and the second inner diameter segment.

In some embodiments, the second inner diameter segment is deeper in the tube body than the first inner diameter segment.

In some embodiments, the tube body and/or the elastic tube plug is provided with a position-limit mechanism that prevents the elastic tube plug from rising and/or descending relative to the tube body along the depth direction.

In some embodiments, the tube body and/or the elastic tube plug is provided with one or more of the following position-limit mechanisms:
a first position-limit mechanism that prevents the elastic tube plug from coming out from the nozzle of the tube body;
a second position-limit mechanism that prevents the elastic tube plug from entering the second inner diameter segment from the first inner diameter segment;
a third position-limit mechanism that prevents the elastic tube plug from reaching a depth beyond the tube plug accommodating segment.

In some aspects, the present disclosure provides a reagent container, comprising:
a tube body, which comprises a tube plug accommodating segment;
an elastic tube plug, which comprises a third outer diameter segment and a fourth outer diameter segment according to the order of entering the tube plug accommodating segment, in which the outer diameter of the fourth outer diameter segment is greater than the outer diameter of the third outer diameter segment, and the elastic tube plug is provided with a through-channel along the direction of entering the tube body;
wherein, the third outer diameter segment is capable of being in non-interference fit or having a first amount of interference fit with the tube plug accommodating segment, and the fourth outer diameter segment is capable of having a second amount of interference fit with the tube plug accommodating segment;
when the third outer diameter segment is capable of being in non-interference fit with the tube plug accommodating segment, the second amount of interference fit is greater than zero; when the third outer diameter segment is capable of having the first amount of interference fit with the tube plug accommodating segment, the second amount of interference fit is greater than the first amount of interference fit;
wherein, the through-channel is configured to be compressed and sealed with the radial contraction of the fourth outer diameter segment when the fourth outer diameter segment has the second amount of interference fit with the tube plug accommodating segment.

In some embodiments, at least one inner diameter of the tube plug accommodating segment is greater than or equal to the outer diameter of the third outer diameter segment.

In some embodiments, at least one inner diameter of the tube plug accommodating segment is smaller than the outer diameter of the fourth outer diameter segment.

In some embodiments, at a third depth where the elastic tube plug enters the tube body, the third outer diameter segment is in non-interference fit or has the first amount of interference fit with the tube plug accommodating segment; at a fourth depth where the elastic tube plug enters the tube body, the fourth outer diameter segment has the second amount of interference fit with the tube plug accommodating segment, and the fourth depth is greater than the third depth.

In some embodiments, at a first depth where the elastic tube plug enters the tube body, the third outer diameter segment is in non-interference fit or has the first amount of interference fit with the tube plug accommodating segment; at a second depth where the elastic tube plug enters the tube body, the fourth outer diameter segment has the second amount of interference fit with the tube plug accommodating segment, and the second depth is greater than the first depth.

In some embodiments, the average outer diameter of the third outer diameter segment is less than the average outer diameter of the fourth outer diameter segment.

In some embodiments, the third outer diameter segment and the fourth outer diameter segment are directly adjacent.

In some embodiments, a chamfered surface is provided between the third outer diameter segment and the fourth outer diameter segment.

In some embodiments, the third outer diameter segment gradually increases in outer diameter at a position adjacent to the fourth outer diameter segment.

In some embodiments, the fourth outer diameter segment gradually decreases in outer diameter at a position adjacent to the third outer diameter segment.

In some embodiments, the tube body and/or the elastic tube plug is provided with a position-limit mechanism that prevents the elastic tube plug from rising and/or descending relative to the tube body along the depth direction.

In some embodiments, the position-limit mechanism comprises one or more of the following:
a first position-limit mechanism that prevents the elastic tube plug from coming out from the nozzle of the tube body;
a third position-limit mechanism that prevents the elastic tube plug from reaching a depth beyond the tube plug accommodating segment;
a fourth position-limit mechanism that prevents the fourth outer diameter segment of the elastic tube plug from entering the tube plug accommodating segment.

In some embodiments, the reagent container is configured such that when the elastic tube plug enters the tube body to a first depth, the elastic tube plug is in non-interference fit or has the first amount of interference fit with the tube plug accommodating segment, and the through-channel is not compressed to form a sealed state or is compressed to form a first sealed state; and when the elastic tube plug enters the tube body to a second depth, the elastic tube plug has the second amount of interference fit with the tube plug accommodating segment, and the through-channel is compressed to form a second sealed state; wherein, the second depth is greater than the first depth, and the degree of sealing of the through-channel in the second sealed state is greater than that in the first sealed state.

In some embodiments, the second sealed state is an air-tight seal.

In some embodiments, the through-channel comprises a second channel segment and a first channel segment according to the order in which the elastic tube plug enters the tube body.

In some embodiments, the cross-sectional area of the first channel segment is greater than the cross-sectional area of the second channel segment.

In some embodiments, the channel cross-sectional shape of the first channel segment is a two-dimensional shape, and the channel cross-sectional shape of the second channel segment is a one-dimensional shape.

In some embodiments, the elastic tube plug further comprises a sealing element, and the sealing element is used for sealing the through-channel.

In some embodiments, the sealing element is detachable.

In some embodiments, the sealing element is pierceable.

In some embodiments, the reagent container according to any one of the above items is a nucleic acid detection reaction tube.

In some embodiments, the reagent container according to any one of the above items is a PCR tube.

In some aspects, the present disclosure provides a method for operating a reagent container, which comprises the following steps:
a) providing the reagent container according to any one of the above items, in which a elastic tube plug of the reagent container has been fitted with a first inner diameter segment, but has not yet been interference-fitted with a second inner diameter segment;
b) using a pipette to penetrate a through-channel of the elastic tube plug, to inject a reagent into a tube body and/or pipette a reagent from the tube body;
c) pushing the elastic tube plug to move along the depth direction of the tube body, so that the elastic tube plug has an interference fit with the second inner diameter segment;
preferably, which further comprises:
d) placing the reagent container in a preset environment to allow a reagent in the container to undergo a reaction, such as a reaction related to nucleic acid amplification or nucleic acid detection;
preferably, the method for operating reagent container is a nucleic acid amplification method or a nucleic acid detection method.

In some aspects, the present disclosure provides a method for operating a reagent container, comprising the following steps:
a) providing the reagent container according to any one of the above items, in which a third outer diameter segment of an elastic tube plug of the reagent container has been fitted with a tube plug accommodating segment, but a fourth outer diameter segment has not yet been interference-fitted with the tube plug accommodating segment;
b) using a pipette to penetrate a through-channel of the elastic tube plug to inject a reagent into a tube body and/or pipette a reagent from the tube body;
c) pushing the elastic tube plug to a deeper part of the tube body, so that the fourth outer diameter segment has an interference fit with the tube plug accommodating segment;
preferably, which further comprising:
d) placing the reagent container in a preset environment to allow a reagent in the container to undergo a reaction, such as a reaction related to nucleic acid amplification or nucleic acid detection;
preferably, the method for operating the reagent container is a nucleic acid amplification method or a nucleic acid detection method.

In some embodiments, the method for operating the reagent container is a method for sealing (e.g., sealing multiple times) a nucleic acid detection reaction tube.

In some aspects, the present disclosure provides a system for handling reagent, which comprises:
the reagent container according to any one of the above items;
a pipette, which is configured to penetrate a through-channel of an elastic tube plug, so as to inject a reagent into a tube body and/or pipette a reagent from the tube body; and
a pusher, which is configured to push the elastic tube plug to move along the depth direction of the tube body;
preferably, the system for handling reagent further comprises a manipulator on which the pipette and/or the pusher are mounted.

In some embodiments, the first inner diameter segment or the second inner diameter segment consists of a segment of the tube body, and the inner diameter variation of which along the depth direction of the tube body is less than or equal to ±3%, for example, less than or equal to ±2%, for example, less than or equal to ±1%.

In some embodiments, the third outer diameter segment or the fourth outer diameter segment consists of a segment of the elastic tube plug, and the outer diameter variation of which along the direction of entering the tube body is less than or equal to ±3%, for example, less than or equal to ±2%, for example, less than or equal to ±1%.

In some embodiments, the first channel segment or the second channel segment consists of a segment of the through-channel of the elastic tube plug, and the inner diameter variation of which along the direction that the elastic tube plug enters the tube body is less than or equal to ±3%, for example, less than or equal to ±2%, for example, less than or equal to ±1%.

In some embodiments, the first inner diameter segment is adjacent to the second inner diameter segment.

In some embodiments, the third outer diameter segment is adjacent to the fourth outer diameter segment.

In some embodiments, the first channel segment is adjacent to the second channel segment.

In some embodiments, the first inner diameter segment and the second inner diameter segment do not overlap.

In some embodiments, the third outer diameter segment and the fourth outer diameter segment do not overlap.

In some embodiments, the first channel segment and the second channel segment do not overlap.

In some embodiments, the inner diameter refers to an average inner diameter.

In some embodiments, the outer diameter refers to an average outer diameter.

### Terminology Explanation

If the following terms are used in the present invention, they may have the following meanings:

Various relative terms such as “front”, “back”, “top” and “bottom”, “up”, “down”, “above”, “below”, etc. may be used to facilitate the description of various examples. Relative terms are defined with respect to the conventional orientation of a structure but do not necessarily denote the actual orientation of the structure when it is manufactured or used.

As used in the description and the appended claims, the singular forms “a”, “an” and “the” comprise plural referents unless the context clearly dictates otherwise.

The term “container” refers to a vessel suitable for receiving, storing, transporting and/or releasing a content, such as a test sample (e.g., blood, urine, serum, plasma or liquefied biopsy sample, etc.), a test reagent (e.g., a reagent for immunochemical test, clinical chemistry test, coagulation test, hematology test, molecular biology test, etc.) or a combination thereof.

The term “tube body” may be a vessel having a cylindrical, conical, or rectangular shape. The tube body may have a closed bottom and an open top. The closed bottom of the cylindrical vessel may be round. Non-limiting examples of single cylindrical or conical separation vessel are primary or secondary tubes known in the art. Alternatively, two or more tube bodies may be arranged as a multi-tube assembly. A non-limiting example of such multi-tube assembly is a perforated plate, which is well known in the art.

The term “inner diameter” refers to a diameter for a circular cross-section, or refers to a diameter of a circle with the same area for a non-circular cross-section.

The term “outer diameter” refers to a diameter for a circular cross-section, or refers to a diameter of a circle with the same area for a non-circular cross-section.

The term “through-channel” may be a through hole or a through slit. The cross-section of the through-channel can be a two-dimensional shape, such as circle shape and polygon shape, or a one-dimensional shape (e.g., a slit), and the one-dimensional shape can be “-” shape, “+” shape, “z” shape, “*” shape, etc.

The term “elasticity” may refer to a property of returning to original size and shape after deformation. The material of the elastic tube plug may be a material with an elastic modulus (Young's modulus) of 10⁴ to 10⁸ Pa, such as 10⁵ to 10⁷ Pa, such as 10⁶ to 10⁷ Pa. The material of the elastic tube plug can be an elastomeric polymer, such as rubber or silicone rubber.

The term “position-limit mechanism” can be a convex block, a stopper, a convex plate, a convex ring, a concave-convex mosaic structure between the elastic tube plug and the tube body, and a clamping structure between the elastic tube plug and the tube body.

The depth at a particular location in the tube body refers to the distance from that location to the tube nozzle. For example, “the depth of the elastic tube plug” refers to the distance from the bottom end of the elastic tube plug to the tube nozzle. For example, “the depth of the first inner diameter segment” refers to the distance from the lower edge of the first inner diameter segment to the tube nozzle.

Unless otherwise specified, the term “depth direction” refers to the direction from the nozzle to the bottom of the tube.

The term “amount of interference fit” refers to the extra size of the elastic tube plug (ΔD) when the size of the elastic tube plug in the radial direction (D₁) is compared to the size of the tube body (D₂) with which it is interference fit, ΔD=D₁−D₂, and the largest ΔD shall prevail. The interference degree (i.e., ΔD/D₂) of the amount of interference fit is, for example, greater than 0.01%, such as greater than 0.1%, such as greater than 0.5%, such as greater than 1%, such as >3%, such as greater than 5%, such as >10%, such as greater than 20%. The above-mentioned size D₁ may be the outer diameter of the elastic tube plug, and the size D₂ may be the inner diameter of the tube body.

The term “interference fit” can refer to a situation where there is interference between mating or fitting parts, the interference fit has a negative tolerance.

The terms “interference fit” and “friction fit” and “press fit” are technical terms used interchangeably herein and can refer to the intentional inducing, increasing and/or using of friction/pressure. In the interference fit, the outer side of the elastic tube plug is squeezed against the inner side of the tube body to form a circumferential seal.

The term “pipette” refers to a sharp device capable of penetrating through the through-channel for injecting/extracting a reagent.

The term “pusher” refers to an element capable of applying pressure to the elastic tube plug.

The term “manipulator” is a device capable of moving an object. The moving can be in any direction of three-dimensional space, such as horizontal or vertical direction.

The term “nucleic acid amplification” generally refers to a technique for increasing the number of copies of nucleic acid molecules in a sample. The techniques used for nucleic acid amplification are well known in the art. An example of nucleic acid amplification is the polymerase chain reaction (PCR), in which a nucleic acid sample collected from a subject is contacted with a primer (the nucleic acid sample may be single-stranded or double-stranded, if the nucleic acid sample is double-stranded, the double strand is first dissociated, then annealed and contacted with the primer) to make the primer extend under appropriate conditions, and then the steps of dissociation (denaturation), annealing and extension are repeated to amplify the number of copies of the nucleic acid. Other examples of in vitro amplification techniques comprise strand displacement amplification, transcription-free isothermal amplification, repair chain reaction amplification, ligase chain reaction, gap-filling ligase chain reaction amplification, coupled ligase detection and PCR, as well as RNA non-transcription amplification etc.

The term “nucleic acid” generally refers to a polymeric form of nucleotides (deoxyribonucleotides (dNTPs) or ribonucleotides (rNTPs)) or an analog thereof, of any length. A nucleic acid can have any three-dimensional structure and can perform any known or unknown function. For the invention to which the present application relates, non-limiting examples of nucleic acids comprise DNA, RNA, coding or non-coding region of gene or gene fragment, one or more loci determined by linkage analysis, exon, intron, messenger RNA (mRNA), transfer RNA (tRNA), ribosomal RNA (rRNA), short interfering RNA (siRNA), short hairpin RNA (shRNA), microRNA (miRNA), ribozyme, cDNA, recombinant nucleic acid, branched nucleic acid, plasmid, vector, isolated DNA of any sequence, isolated RNA of any sequence, nucleic acid probe and primer. A nucleic acid may comprise one or more modified nucleotides, such as methylated nucleotides and nucleotide analogs. The nucleotide sequence of a nucleic acid can be interrupted by a non-nucleotide component. Nucleic acids may be further modified after polymerization (e.g., by coupling or binding to a reporter).

The term “reagent” refers to any gaseous, liquid or solid substance. The reagent can be a liquid.

### Beneficial Effects

One or more technical solutions of the present disclosure have the following one or more beneficial effects:
(1) By using a pipette to penetrate the through-channel of the elastic tube plug, the addition and removal of a reagent can be realized without removing the elastic tube plug from the tube body;
(2) By pushing the elastic tube plug deep into the tube body, the compression and sealing of the through-channel can be realized;
(3) Automatic operation is facilitated;
(4) Simple structure;
(5) Low cost.

### BRIEF DESCRIPTION OF THE DRAWINGS

FIG. 1 shows a schematic diagram of the reagent container of one example;

FIG. 2 shows a schematic diagram of the reagent container of another example;

FIG. 3 shows a schematic diagram of the reagent container and the elastic tube plug of still another example;

FIG. 4 shows a schematic diagram of the reagent container of yet another example;

FIG. 5 shows a schematic diagram of the reagent container of yet another example;

FIG. 6 shows a schematic diagram of the system for handling reagent of one example.

### SPECIFIC MODELS FOR CARRYING OUT THE INVENTION

Embodiments of the present invention will be described in detail below in conjunction with examples, but those skilled in the art will understand that the following examples are only used to illustrate the present invention, and should not be considered as limiting the scope of the present invention. Those without indicating the specific conditions in the examples were carried out according to the conventional conditions or the conditions recommended by the manufacturers. The reagents or instruments used which manufacturers were not indicated were all commercially available conventional products.

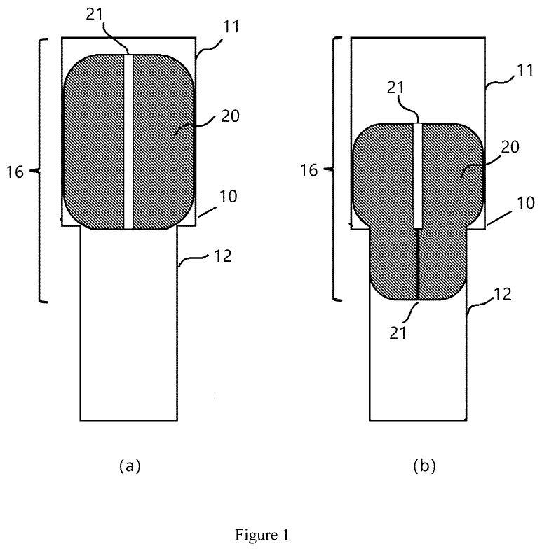

FIG. 1 shows a schematic diagram of a reagent container, wherein (a) and (b) respectively show schematic diagrams of tube plugs at different depths of the tube body. As shown in (a) and (b) of FIG. 1, the reagent container comprises a tube body 10 and an elastic tube plug 20; the tube body 10 comprises a tube plug accommodating segment 16, and the tube plug accommodating segment 16 comprises a first inner diameter segment 11 and a second inner diameter segment 12 along the depth direction of the tube body 10, the inner diameter of the second inner diameter segment 12 is smaller than the inner diameter of the first inner diameter segment 11; the elastic tube plug 20 is provided with a through-channel 21 along the direction of entering the tube body 10; wherein, the elastic tube plug 20 can be in non-interference fit with the first inner diameter segment 11, and the elastic tube plug 20 can have a second amount of interference fit with the second inner diameter segment 12, and the second amount of interference fit is greater than zero; wherein, when the elastic tube plug 20 has the second amount of interference fit with the second inner diameter segment 12, the elastic tube plug 20 is radially compressed and the through-channel 21 is compressed and sealed.

As shown in (a) of FIG. 1, the elastic tube plug 20 enters the tube body 10 at a first depth. The elastic tube plug 20 is located in the first inner diameter segment 11 and has not yet entered the second inner diameter segment 12. The outer diameter of the elastic tube plug 20 is smaller than the inner diameter of the first inner diameter segment 11, and the relationship between the elastic tube plug 20 and the first inner diameter segment 11 is non-interference fit (clearance fit). The elastic tube plug 20 is not radially compressed, and the through-channel 21 is not compressed or sealed. The through-channel 21 is open (in some examples, the through-channel 21 is naturally closed). When the reagent container is in this state, the through-channel 21 of the elastic tube plug 20 can be penetrated with a pipette, and a reagent can be injected into the tube body 10 and/or pipetted from the tube body 10.

As shown in (b) of FIG. 1, the depth of the elastic tube plug 20 entering the tube body 10 is a second depth, and the second depth is greater than the first depth. A portion of the elastic tube plug extends into the second inner diameter segment 12. The outer diameter of the elastic tube plug 20 is greater than the inner diameter of the second inner diameter segment 12, and the relationship between the elastic tube plug 20 and the second inner diameter segment 12 is interference fit. When the reagent container is in this state, the elastic tube plug 20 is radially compressed and the through-channel 21 is compressed and sealed. The reagent container is well sealed.

In some examples, there is provided a method for operating the reagent container described above, which comprises the following steps:
a) providing the above-mentioned reagent container, the elastic tube plug 20 of the reagent container has been fitted with the first inner diameter segment 11, but has not yet been interference-fitted with the second inner diameter segment 12;
b) using a pipette to penetrate the through-channel 21 of the elastic tube plug 20, to inject a reagent into the tube body 10 and/or pipette a reagent from the tube body 10;
c) pushing the elastic tube plug 20 to move along the depth direction of the tube body 10 (to the depth of the tube body), so that the elastic tube plug 20 and the second inner diameter segment 12 have an interference fit;
preferably, which further comprises:
d) placing the reagent container in a preset environment, so that a reagent in the container undergoes a reaction, such as a reaction related to nucleic acid amplification or nucleic acid detection.

In some examples, the method for operating the reagent container is a nucleic acid amplification method or a nucleic acid detection method.

In some examples, as shown in FIG. 1, the elastic tube plug 20 comprises a cylindrical plug body with a constant outer diameter along the direction of entering the tube body.

In some examples, the first inner diameter segment 11 and the second inner diameter segment 12 are directly adjacent. In some examples, a chamfered surface is provided between the first inner diameter segment 11 and the second inner diameter segment 12. In some examples, the first inner diameter segment 11 gradually decreases in inner diameter at a position adjacent to the second inner diameter segment 12. In some examples, the second inner diameter segment 12 gradually increases in inner diameter at a position adjacent to the first inner diameter segment 11. In some examples, the inner diameter at the junction of the first inner diameter segment 11 and the second inner diameter segment 12 has a smooth transition. In the above solutions, the elastic tube plug 20 can be switched more smoothly between the first inner diameter segment 11 and the second inner diameter segment 12.

In one example, the second inner diameter segment 12 is deeper in the tube body 10 than the first inner diameter segment 11. The second inner diameter segment 12 may be adjacent to the first inner diameter segment 11 but does not overlap.

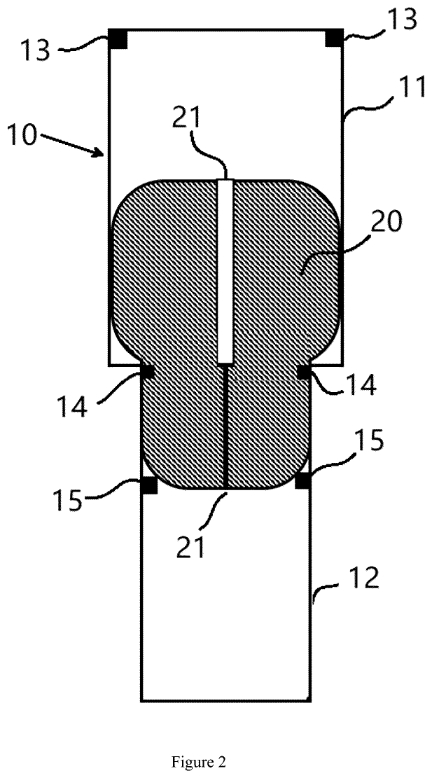

FIG. 2 shows a reagent container with a position-limit mechanism, as shown in FIG. 2, the reagent container is provided with position-limit mechanisms (13, 14, 15) that prevent the elastic tube plug 20 from rising and/or descending relative to the tube body 10 along the depth direction.

In one example, as shown in FIG. 2, the tube body 10 is provided with a first position-limit mechanism 13 (e.g., a limiting block or a limiting ring) that prevents the elastic tube plug 20 from coming out of the tube nozzle. During the use of the reagent container, sometimes it is necessary to use a pipette to penetrate the through-channel 21 of the elastic tube plug 20, so as to inject a reagent into the tube body 10 and/or pipette a reagent from the tube body. When the pipette is pulled out from the through-channel 21, there is a possibility that the elastic tube plug 20 may be taken out of the tube body 10, and the first position-limit mechanism 13 can effectively prevent the elastic tube plug 20 from being taken out of the tube body 10.

In one example, as shown in FIG. 2, the tube body 10 is provided with a second position-limit mechanism 14 (e.g., a limiting block or a limiting ring) that prevents the elastic tube plug 20 from entering the second inner diameter segment 12 from the first inner diameter segment 11. During the use of the reagent container, sometimes it is necessary to use a pipette to penetrate the through-channel 21 of the elastic tube plug 20 to inject a reagent into the tube body 10 and/or pipette a reagent from the tube body. When inserting the pipette, there is a possibility of pushing the elastic tube plug 20 to a deeper part of the tube body 10, for example to the second inner diameter segment 12. The second position-limit mechanism 14 can effectively prevent the elastic tube plug 20 from being pushed to the second inner diameter segment 12.

In one example, as shown in FIG. 2, the tube body 10 is provided with a third position-limit mechanism 15 (e.g., a limiting block or a limiting ring) that prevents the elastic tube plug 20 from reaching a depth beyond the tube plug accommodating segment 16. During the use of the reagent container, sometimes it is necessary to push the elastic tube plug 20 to a deeper part of the tube body 10 so that the elastic tube plug 20 and the second inner diameter segment 12 have interference fit. During the process of pushing the elastic tube plug 20, there may be a possibility of pushing the elastic tube plug 20 to a deeper position of the tube plug accommodating segment 16. The third position-limit mechanism 15 can effectively prevent the elastic tube plug 20 from being pushed to a position deeper than the tube plug accommodating segment 16.

It can be understood that the above-mentioned position-limit mechanisms (e.g., the first position-limit mechanism, the second position-limit mechanism and the third position-limit mechanism) can all be elastic position-limit mechanisms, that is, when the applied stress exceeds the load of the position-limit mechanism, the elastic tube plug can break through the position-limit mechanism.

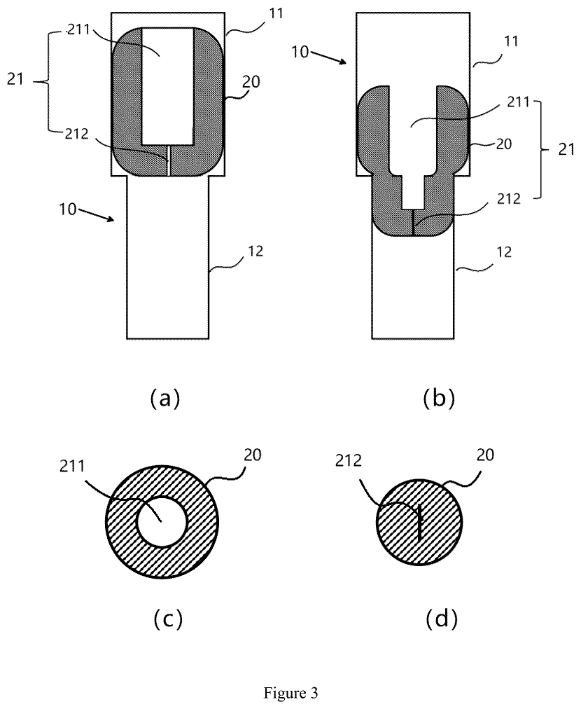

FIG. 3 shows a schematic diagram of still another reagent container, wherein (a) and (c) respectively show a longitudinal section view of the reagent container and a cross-section view of the elastic tube plug when the elastic tube plug is located in the first inner diameter segment, while (b) and (d) respectively show a longitudinal section view of the reagent container and a cross-section view of the elastic tube plug when the elastic tube plug is located in the second inner diameter segment. As shown in FIG. 3, according to the order in which the elastic tube plug 20 is inserted into the tube body 10, the through-channel 21 comprises a second channel segment 212 and a first channel segment 211, and the cross-sectional area of the first channel segment 211 is larger than that of the second channel segment 212. During the process of using the reagent container, sometimes it is necessary to use a pipette to penetrate through the through-channel 21 of the elastic tube plug 20 to inject a reagent into the tube body 10 and/or pipette a reagent from the tube body. The pipette can pass through easily if the through-channel has a larger inner diameter. At the same time, during the process of using the reagent container, after injecting and pipetting the required reagent, sometimes it is necessary to make the elastic tube plug 20 and the second inner diameter segment 12 have interference fit, so that the elastic tube plug 20 is radially compressed and the through-channel 21 is compressed and sealed. If the through-channel has a small inner diameter, it can be easily compressed and sealed. According to the above solution, the cross-sectional area of the first channel segment 211 of the through-channel 21 is larger, making it easy for a pipette to pass through, and the cross-sectional area of the second channel segment 212 is smaller, making it easy to be compressed and sealed. This solution improves the usability and sealing of the reagent container.

As shown in (a) of FIG. 3, the depth of the elastic tube plug 20 entering the tube body 10 is a first depth. The elastic tube plug 20 is located in the first inner diameter segment 11 and has not yet entered the second inner diameter segment 12. The outer diameter of the elastic tube plug 20 is smaller than the inner diameter of the first inner diameter segment 11, and the relationship between the elastic tube plug 20 and the first inner diameter segment 11 is non-interference fit (clearance fit). Both the first channel segment 211 and the second channel segment 212 have not yet been compressed and sealed.

As shown in (b) of FIG. 3, the depth of the elastic tube plug 20 entering the tube body 10 is a second depth, and the second depth is greater than the first depth. A portion of the elastic tube plug enters the second inner diameter segment 12. The outer diameter of the elastic tube plug 20 is larger than the inner diameter of the second inner diameter segment 12, and the relationship between the elastic tube plug 20 and the second inner diameter segment 12 is interference fit. When the reagent container is in this state, the elastic tube plug 20 is radially compressed and the second channel segment 212 of the through-channel 21 is compressed and sealed. The reagent container is well sealed.

As shown in (c) and (d) of FIG. 3, the cross-sectional shape of the first channel segment 211 is a two-dimensional shape, such as a circle shape, and the cross-sectional shape of the second channel segment 212 is a one-dimensional shape, such as “-” shape. Due to the elasticity of the elastic tube plug, even if the cross-sectional shape of the second channel segment 212 is a one-dimensional shape, the pipette can penetrate the channel. In this solution, the shape of the first channel segment 211 is convenient for passing a pipette, and the shape of the second channel segment 212 is convenient for being compressed and sealed. This solution improves the usability and sealing performance of the reagent container.

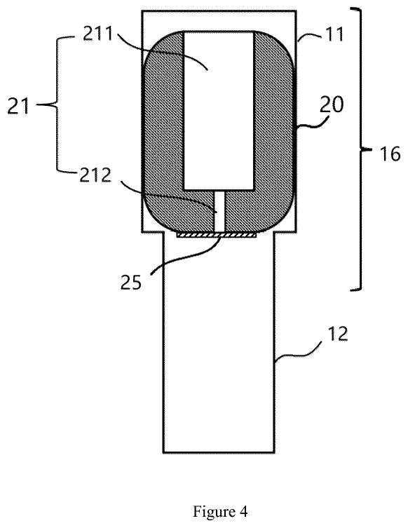

FIG. 4 shows a schematic diagram of yet another reagent container. As shown in the figure, a sealing element 25 is provided on the elastic tube plug 20 of the reagent container, and the sealing element 25 seals the through-channel 21. The sealing element 25 is a pierceable sealing element. For the reagent container that has not been put into use, the elastic tube plug 20 can be fitted with the first inner diameter segment 11 in advance, and the sealing element 25 can seal the through-channel 21 at this time, thereby preventing impurities from entering the container. When it is necessary to inject a reagent into the tube body 10 and/or pipette a reagent from the tube body, a pipette can be used to pierce the sealing element 25.

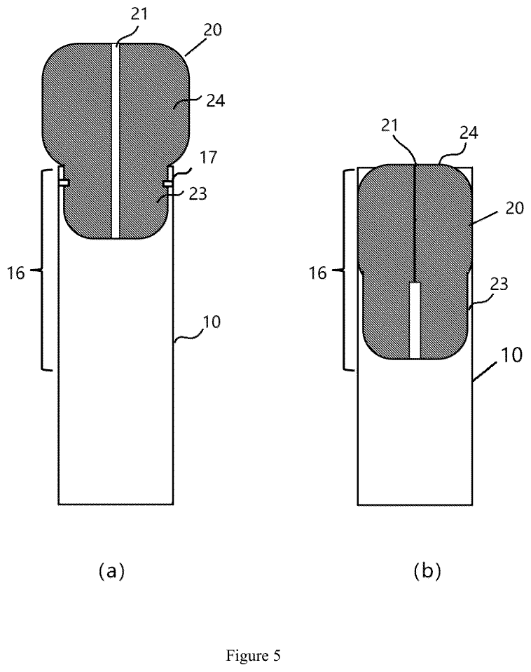

FIG. 5 shows a schematic diagram of yet another reagent container. As shown in the figure, the reagent container comprises a tube body 10 and an elastic tube plug 20. The tube body 10 comprises a tube plug accommodating segment 16. The elastic tube plug 20 comprises a third outer diameter segment 23 and a fourth outer diameter segment 24 according to the order of entering the tube plug accommodating segment 16, wherein the outer diameter of the fourth outer diameter segment 24 is greater than the outer diameter of the third outer diameter segment 23. The elastic tube plug 20 is provided with a through-channel 21 in the direction of entering the tube body. The third outer diameter segment 23 is in non-interference fit with the tube plug accommodating segment 16, and the fourth outer diameter segment 24 has a second amount of interference fit with the tube plug accommodating segment 16, and the second amount of interference fit is greater than zero. The elastic tube plug 20 is configured such that when the fourth outer diameter segment 24 has the second amount of interference fit with the tube plug accommodating segment 16, the fourth outer diameter segment 24 is radially compressed and the through-channel 21 is compressed and sealed.

As shown in (a) of FIG. 5, the depth of the elastic tube plug 20 entering the tube body 10 is a first depth. The third outer diameter segment 23 of the elastic tube plug 20 enters the tube plug accommodating segment 16, and the fourth outer diameter segment 24 has not yet entered the tube plug accommodating segment 16. The outer diameter of the third outer diameter segment 23 is smaller than the inner diameter of the tube plug accommodating segment 16, and the relationship between the tube plug accommodating segment 16 and the third outer diameter segment 23 is non-interference fit (clearance fit). The third outer diameter segment 23 is not radially compressed, and the through-channel 21 is not compressed or sealed. The through-channel 21 is open and penetrable by a pipette. In this state, a pipette can be used to penetrate the through-channel 21 of the elastic tube plug 20 to inject a reagent into the tube body 10 and/or pipette a reagent from the tube body 10.

As shown in (b) of FIG. 5, the depth of the elastic tube plug 20 entering the tube body 10 is a second depth, and the second depth is greater than the first depth. At least part of the fourth outer diameter segment 24 of the elastic tube plug enters the tube plug accommodating segment 16. The outer diameter of the fourth outer diameter segment 24 is larger than the inner diameter of the tube plug accommodating segment 16, and the relationship between the fourth outer diameter segment 24 and the tube plug accommodating segment 16 is interference fit. The fourth outer diameter segment 24 is radially compressed and the through-channel 21 is compressed and sealed. In this state, the reagent container is well sealed.

In some examples, there is provided a method for operating the reagent container described above, comprising the following steps:
a) providing the above-mentioned reagent container, in which the third outer diameter segment 23 of the elastic tube plug 20 of the reagent container has been fitted with the tube plug accommodating segment 16, but the fourth outer diameter segment 24 has not yet been in interference fit with the tube plug accommodating segment 16;
b) using a pipette to penetrate through the through-channel 21 of the elastic tube plug 20 to inject a reagent into the tube body 10 and/or pipette a reagent from the tube body 10;
c) pushing the elastic tube plug 20 to a deeper part of the tube body 10, so that the fourth outer diameter segment 24 has interference fit with the tube plug accommodating segment 16;
preferably, the method for operating the reagent container further comprising:
d) placing the reagent container in a preset environment, so that a reagent in the container undergoes a reaction, such as a reaction related to nucleic acid amplification or nucleic acid detection.

In some examples, the method for operating the reagent container is a nucleic acid amplification method or a nucleic acid detection method.

In some examples, as shown in FIG. 5, the tube plug accommodating segment 16 comprises a cylindrical lumen with a constant inner diameter along the depth direction of the tube body.

In some examples, as shown in (a) of FIG. 5, the reagent container is provided with a position-limit mechanism 17 that prevents the elastic tube plug 20 from rising and/or descending relative to the tube body 10 in the depth direction. The position-limit mechanism 17 comprises a groove on the third outer diameter segment 23 and a convex block on the tube plug accommodating segment 16, and the groove and the convex block can be fitted and engaged. The position-limit mechanism 17 can prevent the elastic tube plug 20 from coming out of the nozzle.

In some examples, the third outer diameter segment 23 and the fourth outer diameter segment 24 are directly adjacent. In some examples, a chamfered surface is provided between the third outer diameter segment 23 and the fourth outer diameter segment 24. In some examples, the third outer diameter segment 23 gradually increases in outer diameter at a position adjacent to the fourth outer diameter segment 24. In some examples, the fourth outer diameter segment 24 gradually decreases in outer diameter at a position adjacent to the third outer diameter segment 23. In the above solution, the fitting states between the elastic tube plug 20 and the tube plug accommodating segment 16 can be switched more smoothly. In the above examples, the fitting relationship between the elastic tube plug and the tube plug accommodating segment can be easily switched.

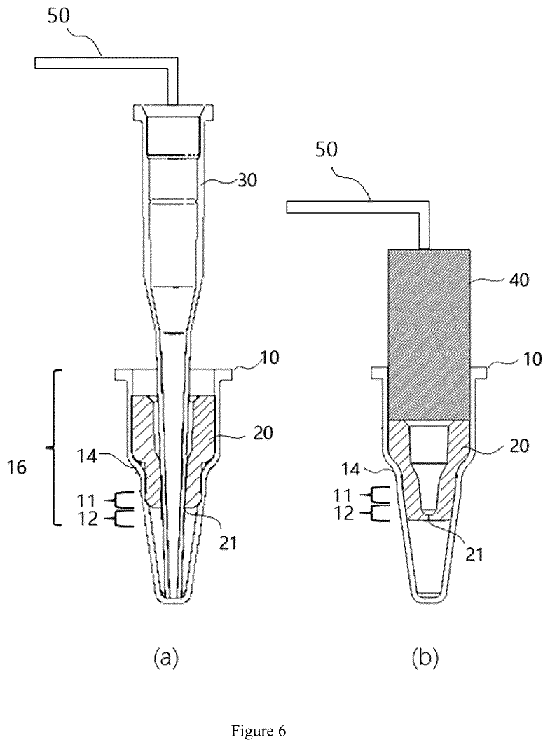

FIG. 6 shows a schematic diagram of a system for handling reagent. In some examples, a system for handling reagent is provided, which comprises:
a reagent container, which comprises a tube body 10 and an elastic tube plug 20, in which the tube body 10 comprises a tube plug accommodating segment 16, the tube plug accommodating segment 16 comprises a first inner diameter segment 11 and a second inner diameter segment 12 along the depth direction of the tube body 10, the inner diameter of the second inner diameter segment 12 is smaller than the inner diameter of the first inner diameter segment 11; the elastic tube plug 20 is provided with a through-channel 21 along the direction of entering the tube body 10; wherein, the elastic tube plug 20 is capable of having a first amount of interference fit with the first inner diameter segment 11, the elastic tube plug 20 is capable of having a second amount of interference fit with the second inner diameter segment 12, and the second amount of interference fit is greater than the first amount of interference fit; wherein, when the elastic tube plug 20 has the second amount of interference fit with the second inner diameter segment 12, the elastic tube plug 20 is radially compressed and the through-channel 21 is compressed and sealed;
a pipette 30, which is configured to penetrate the through-channel 21 of the elastic tube plug 20 to inject a reagent into the tube body 10 and/or pipette a reagent from the tube body; and
a pusher 40, which is configured to push the elastic tube plug 20 to move along the depth direction of the tube body 10.

The method for operating the system for handling reagent described above comprises the following steps:
a) providing the above-mentioned reagent container, in which the elastic tube plug 20 of the reagent container has been fitted with the first inner diameter segment 11, but has not yet been in interference fit with the second inner diameter segment 12;
b) using a pipette to penetrate through the through-channel 21 of the elastic tube plug 20 to inject a reagent into the tube body 10 and/or pipette a reagent from the tube body 10;
c) pushing the elastic tube plug 20 to move along the depth direction of the tube body 10 (to a deeper part of the tube body), so that the elastic tube plug 20 and the second inner diameter segment 12 have interference fit;
preferably, which further comprises:
d) placing the reagent container in a preset environment, so that a reagent in the container undergoes a reaction, such as a reaction related to nucleic acid amplification or nucleic acid detection.

In some examples, as shown in (a) of FIG. 6, the tube body 10 is provided with a second position-limit mechanism 14 that prevents the elastic tube plug 20 from entering the second inner diameter segment 12 from the first inner diameter segment 11. The second position-limit mechanism 14 prevents the elastic tube plug 20 from being brought deeper when the pipette passes through the through-channel 21. As shown in (b) of FIG. 6, the stress applied by the pusher 40 exceeds the load of the second position-limit mechanism 14, and the elastic tube plug 20 breaks through the second position-limit mechanism 14 under the pressure of the pusher 40 and reaches the second inner diameter segment 12.

In some examples, the system for handling reagent further comprises a manipulator 50 on which the pipette 30 and/or the pusher 40 are mounted.

Although the specific embodiments of the present invention has been described in detail, those skilled in the art will understand that various modifications and changes can be made to the details according to all the teachings that have been disclosed, and these changes are all within the protection scope of the present invention. The full scope of the present invention is given by the appended claims and any equivalents thereof.

1. A reagent container, comprising:
a tube body, which comprises a tube plug accommodating segment, and the tube plug accommodating segment comprises a first inner diameter segment and a second inner diameter segment along the depth direction of the tube body, the inner diameter of the second inner diameter segment is smaller than the inner diameter of the first inner diameter segment;
an elastic tube plug, in which the elastic tube plug is provided with a through-channel along the direction of entering the tube body;
wherein, the elastic tube plug is capable of being in non-interference fit or having a first amount of interference fit with the first inner diameter segment, and the elastic tube plug is capable of having a second amount of interference fit with the second inner diameter segment;
when the elastic tube plug is capable of being in non-interference fit with the first inner diameter segment, the second amount of interference fit is greater than zero; when the elastic tube plug is capable of having the first amount of interference fit with the first inner diameter segment, the second amount of interference fit is greater than the first amount of interference fit;
wherein, the through-channel is configured to be compressed and sealed with the radial contraction of the elastic tube plug when the elastic tube plug has the second amount of interference fit with the second inner diameter segment.

2. The reagent container according to claim 1, which has one or more of the following characteristics:
the inner diameter of the first inner diameter segment is greater than or equal to at least one outer diameter of the elastic tube plug;
the inner diameter of the second inner diameter segment is smaller than at least one outer diameter of the elastic tube plug;
the elastic tube plug is in non-interference fit or has the first amount of interference fit with the first inner diameter segment at a first depth of entering the tube body, and has the second amount of interference fit with the second inner diameter segment at a second depth of entering the tube body, and the second depth is greater than the first depth.

3. The reagent container according to claim 1, which has one or more of the following characteristics:
the first inner diameter segment and the second inner diameter segment are directly adjacent;
a chamfered surface is provided between the first inner diameter segment and the second inner diameter segment;
the first inner diameter segment gradually decreases in inner diameter at a position adjacent to the second inner diameter segment;
the second inner diameter segment gradually increases in inner diameter at a position adjacent to the first inner diameter segment;
a smooth inner diameter transition is provided at the junction of the first inner diameter segment and the second inner diameter segment;
the second inner diameter segment is deeper in the tube body than the first inner diameter segment.

4. The reagent container according to claim 1, wherein the tube body and/or the elastic tube plug is provided with a position-limit mechanism that prevents the elastic tube plug from rising and/or descending relative to the tube body along the depth direction;
alternatively, the tube body and/or the elastic tube plug is provided with one or more of the following position-limit mechanisms:
a first position-limit mechanism that prevents the elastic tube plug from coming out from the nozzle of the tube body;
a second position-limit mechanism that prevents the elastic tube plug from entering the second inner diameter segment from the first inner diameter segment;
a third position-limit mechanism that prevents the elastic tube plug from reaching a depth beyond the tube plug accommodating segment.

5. A reagent container, comprising:
a tube body, which comprises a tube plug accommodating segment;
an elastic tube plug, which comprises a third outer diameter segment and a fourth outer diameter segment according to the order of entering the tube plug accommodating segment, in which the outer diameter of the fourth outer diameter segment is larger than the outer diameter of the third outer diameter segment, and the elastic tube plug is provided with a through-channel along the direction of entering the tube body;
wherein, the third outer diameter segment is capable of being in non-interference fit or having a first amount of interference fit with the tube plug accommodating segment, and the fourth outer diameter segment is capable of having a second amount of interference fit with the tube plug accommodating segment;
when the third outer diameter segment is capable of being in non-interference fit with the tube plug accommodating segment, the second amount of interference fit is greater than zero; when the third outer diameter segment is capable of having the first amount of interference fit with the tube plug accommodating segment, the second amount of interference fit is greater than the first amount of interference fit;
wherein, the through-channel is configured to be compressed and sealed with the radial contraction of the fourth outer diameter segment when the fourth outer diameter segment has the second amount of interference fit with the tube plug accommodating segment.

6. The container according to claim 5, which has one or more of the following characteristics:
at least one inner diameter of the tube plug accommodating segment is greater than or equal to the outer diameter of the third outer diameter segment;
at least one inner diameter of the tube plug accommodating segment is smaller than the outer diameter of the fourth outer diameter segment;
at a first depth where the elastic tube plug enters the tube body the third outer diameter segment is in non-interference fit or has the first amount of interference fit with the tube plug accommodating segment; at a second depth where the elastic tube plug enters the tube body the fourth outer diameter segment has the second amount of interference fit with the tube plug accommodating segment, and the second depth is greater than the first depth.

7. The container according to claim 6, which has one or more of the following characteristics:
the third outer diameter segment and the fourth outer diameter segment are directly adjacent;
a chamfered surface is provided between the third outer diameter segment and the fourth outer diameter segment;
the third outer diameter segment gradually increases in outer diameter at a position adjacent to the fourth outer diameter segment;
the fourth outer diameter segment gradually decreases in outer diameter at a position adjacent to the third outer diameter segment.

8. The reagent container according to claim 5, wherein the tube body and/or the elastic tube plug is provided with a position-limit mechanism that prevents the elastic tube plug from rising and/or descending relative to the tube body along the depth direction;
alternatively, the position-limit mechanism comprises one or more of the following:
a first position-limit mechanism that prevents the elastic tube plug from coming out from the nozzle of the tube body;
a third position-limit mechanism that prevents the elastic tube plug from reaching a depth beyond the tube plug accommodating segment;
a fourth position-limit mechanism that prevents the fourth outer diameter segment of the elastic tube plug from entering the tube plug accommodating segment.

9. The reagent container according to claim 1, which is configured such that when the elastic tube plug enters the tube body to a first depth, the elastic tube plug is in non-interference fit or has the first amount of interference fit with the tube plug accommodating segment, and the through-channel is not compressed to form a sealed state or is compressed to form a first sealed state; and when the elastic tube plug enters the tube body to a second depth, the elastic tube plug has the second amount of interference fit with the tube plug accommodating segment, and the through-channel is compressed to form a second sealed state;
wherein, the second depth is greater than the first depth, and the sealing degree of the second sealed state of the through-channel is greater than that of the first sealed state;
alternatively, the second sealed state is an air-tight seal.

10. The reagent container according to claim 1, wherein, according to the order in which the elastic tube plug enters the tube body, the through-channel comprises a second channel segment and a first channel segment, which has one or more of the following characteristics:
the cross-sectional area of the first channel segment is greater than the cross-sectional area of the second channel segment;
the channel cross-sectional shape of the first channel segment is a two-dimensional shape, and the channel cross-sectional shape of the second channel segment is a one-dimensional shape.

11. The reagent container according to claim 1, wherein the elastic tube plug further comprises a sealing element, and the sealing element is used to seal the through-channel;
alternatively, the sealing element is detachable;
or, the sealing element is pierceable.

12. The reagent container according to claim 1, wherein the reagent container is a PCR tube.

13. A method for operating a reagent container, comprising the following steps:
a) providing the reagent container according to claim 1, in which an elastic tube plug of the reagent container has been fitted with a first inner diameter segment, but has not yet been in interference fit with a second inner diameter segment;
b) using a pipette to penetrate a through-channel of the elastic tube plug to inject a reagent into a tube body and/or pipette a reagent from the tube body;
c) pushing the elastic tube plug to move along the depth direction of the tube body, so that the elastic tube plug is in interference fit with the second inner diameter segment;
alternatively, further comprising:
d) placing the reagent container in a preset environment to allow a reagent in the container to undergo a reaction, such as a reaction related to nucleic acid amplification or nucleic acid detection;
alternatively, the method for operating the reagent container is a nucleic acid amplification method or a nucleic acid detection method.

14. A method for operating a reagent container, comprising the following steps:
a) providing the reagent container according to claim 5, in which a third outer diameter segment of an elastic tube plug of the reagent container has been fitted with a tube plug accommodating segment, but a fourth outer diameter segment has not yet been in interference fit with the tube plug accommodating segment;
b) using a pipette to penetrate a through-channel of the elastic tube plug to inject a reagent into a tube body and/or pipette a reagent from the tube body;
c) pushing the elastic tube plug to a deeper part of the tube body, so that the fourth outer diameter segment is in interference fit with the tube plug accommodating segment;
alternatively, further comprising:
d) placing the reagent container in a preset environment to allow a reagent in the container to undergo a reaction, such as a reaction related to nucleic acid amplification or nucleic acid detection;
alternatively, the method for operating the reagent container is a nucleic acid amplification method or a nucleic acid detection method.

15. A system for handling reagent, comprising
the reagent container according to claim 1;
a pipette, which is configured to penetrate a through-channel of an elastic tube plug to inject a reagent into a tube body and/or pipette a reagent from the tube body; and
a pusher, which is configured to push the elastic tube plug to move along the depth direction of the tube body;
alternatively, the system for handling reagent further comprises a manipulator on which the pipette and/or the pusher are mounted.

16. The reagent container according to claim 5, which is configured such that when the elastic tube plug enters the tube body to a first depth, the elastic tube plug is in non-interference fit or has the first amount of interference fit with the tube plug accommodating segment, and the through-channel is not compressed to form a sealed state or is compressed to form a first sealed state; and when the elastic tube plug enters the tube body to a second depth, the elastic tube plug has the second amount of interference fit with the tube plug accommodating segment, and the through-channel is compressed to form a second sealed state;
wherein, the second depth is greater than the first depth, and the sealing degree of the second sealed state of the through-channel is greater than that of the first sealed state;
alternatively, the second sealed state is an air-tight seal.

17. The reagent container according to claim 5, wherein, according to the order in which the elastic tube plug enters the tube body, the through-channel comprises a second channel segment and a first channel segment, which has one or more of the following characteristics:
the cross-sectional area of the first channel segment is greater than the cross-sectional area of the second channel segment;
the channel cross-sectional shape of the first channel segment is a two-dimensional shape, and the channel cross-sectional shape of the second channel segment is a one-dimensional shape.

18. The reagent container according to claim 5, wherein the elastic tube plug further comprises a sealing element, and the sealing element is used to seal the through-channel;
alternatively, the sealing element is detachable;
or, the sealing element is pierceable.

19. The reagent container according to claim 5, wherein the reagent container is a PCR tube.

20. A system for handling reagent, comprising
the reagent container according to claim 5;
a pipette, which is configured to penetrate a through-channel of an elastic tube plug to inject a reagent into a tube body and/or pipette a reagent from the tube body; and
a pusher, which is configured to push the elastic tube plug to move along the depth direction of the tube body;
alternatively, the system for handling reagent further comprises a manipulator on which the pipette and/or the pusher are mounted.
